(19) United States
(12) Patent Application Publication
(10) Pub. No.: US 2018/0079673 A1
(43) Pub. Date: Mar. 22, 2018

(54) METHOD AND SYSTEM FOR REDUCING WATER CONTENT IN WATER-AND-SOLID-CONTAINING SUBSTANCE

(71) Applicant: General Electric Company, Schenectady, NY (US)

(72) Inventors: Yiwen SUN, Shanghai (CN); Hai YANG, Shanghai (CN); Jiyang XIA, Shanghai (CN); Yu DONG, Shanghai (CN); Chunjie LIU, Shanghai (CN); Lu HE, Shanghai (CN); Zhenjiang YU, Shanghai (CN); Yitong LI, Shanghai (CN)

(21) Appl. No.: 15/711,859

(22) Filed: Sep. 21, 2017

(30) Foreign Application Priority Data
Sep. 22, 2016 (CN) 201610840103.8

(51) Int. Cl. C02F 11/14

(52) U.S. Cl. CPC C02F 11/14

(57) ABSTRACT

A method and system for reducing a water content in a substance, comprising: mixing a water-and-solid-containing substance with a liquefied gas solvent creating a mixture and at least part of water in the water-and-solid-containing substance to be extracted into the liquefied gas solvent; separating the mixture into a substance with a decreased water content and a solvent with an increased water content, comprising the liquefied gas solvent and water extracted from the water-and-solid-containing substance; separating the solvent with an increased water content into a liquefied-gas-solvent-rich phase and a water-rich phase by changing a temperature of the solvent with an increased water content, and in a process of changing the temperature, keeping the temperature to be lower than a boiling point of the liquefied gas solvent under a pressure in the process; and returning at least part of the liquefied-gas-solvent-rich phase to be used as a solvent in creating the mixture.

### FIELD OF INVENTION

The present disclosure generally relates to a method and a system for reducing a water content in a water-and-solid-containing substance.

### BACKGROUND OF THE INVENTION

A great amount of semisolid residues containing water and liquid organic matters are possibly produced in production and life. For example, sludge accounting for 0.5 wt % (weight percentage) of treated water is possibly produced in a water treatment process. Sludge not only contains solid residues, but also contains water having a content possibly up to 99 wt %. Besides, it possibly further contains a certain amount of organic matters, e.g., oils such as animal and plant oils and mineral oil. In order to decrease the amount of residues which finally need to be treated, generally the water content in the semisolid residues needs to be reduced as much as possible. Common methods for reducing the water content in the semisolid residues include concentration and dewatering treatment (by adding flocculants and performing press filtration) and drying treatment. The concentration and dewatering treatment can only reduce the water content to a limited extent. Even after the concentration and dewatering treatment, the water content of the residues is still possibly up to 80 wt %. Therefore, thermal drying for water removal is usually further performed on the residues after the concentration and dewatering treatment to further reduce the water content. However, since water needs to be removed by evaporation, the energy consumption of the thermal drying method is comparatively high, usually about 1000 kWh of energy needs to be consumed for removing 1 ton of water, and it is very difficult for the thermal drying method to remove organic matters such as oil and fat from the residues.

Chinese Patent Application CN102046540A discloses a method for reducing a water content in a sludge by using liquid dimethyl ether (DME), in which the liquid dimethyl ether is used for contacting the sludge such that water in the sludge is dissolved into the liquid dimethyl ether, solid-liquid separation is performed to obtain a mixture of the liquid dimethyl ether and the water dissolved out of the sludge, the mixture is fed into a distillation column to evaporate dimethyl ether gas, then the dimethyl ether gas is compressed and cooled to be liquefied, and finally the liquefied dimethyl ether is recycled. Since dimethyl ether can be easily turned into gas from liquid, as compared with the traditional thermal drying method, this method greatly reduces the energy consumption. However, the overall energy consumption is still not low. Thus, there is still room for reduction.

Therefore, it is desirable to provide a more energy-saving method for reducing a water content in a water-containing substance such as sludge.

### SUMMARY OF INVENTION

In one aspect, a method for reducing a water content in a water-and-solid-containing substance comprises: (a) mixing the water-and-solid-containing substance with a liquefied gas solvent to obtain a mixture and enabling at least part of water in the water-and-solid-containing substance to be extracted into the liquefied gas solvent; (b) separating the mixture into a substance with a decreased water content and a solvent with an increased water content, the solvent with an increased water content comprising the liquefied gas solvent and water extracted from the water-and-solid-containing substance; (c) separating the solvent with an increased water content into a liquefied-gas-solvent-rich phase and a water-rich phase by changing a temperature of the solvent with an increased water content, and in a process of changing the temperature, keeping the temperature to be lower than a boiling point of the liquefied gas solvent under a pressure in the process; and (d) returning at least part of the liquefied-gas-solvent-rich phase to step (a) to be used as a solvent.

In another aspect, a system for reducing a water content in a water-and-solid-containing substance comprises: an extraction device for mixing the water-and-solid-containing substance with a liquefied gas solvent to obtain a mixture and enabling at least part of water in the water-and-solid-containing substance to be extracted into the liquefied gas solvent; a solid-liquid separation device for separating the mixture into a substance with a decreased water content and a solvent with an increased water content, the solvent with an increased water content comprising the liquefied gas solvent and water extracted from the water-and-solid-containing substance; a liquid-liquid separation device for separating the solvent with an increased water content into a liquefied-gas-solvent-rich phase and a water-rich phase by changing a temperature of the solvent with an increased water content, and in a process of changing the temperature, keeping the temperature to be lower than a boiling point of the liquefied gas solvent under a pressure in the process; and a recycling device for returning at least part of the liquefied-gas-solvent-rich phase to the extraction device to be used as solvent.

### BRIEF DESCRIPTION OF THE DRAWINGS

These and other features, aspects and advantages of the present disclosure can be better understood in light of the following detailed description with reference to the accompanying drawings in which the same reference number indicates the same element throughout the drawings, wherein:

FIG. 1 illustrates a schematic diagram of a system for reducing a water content in a water-and-solid-containing substance according to one embodiment of the present disclosure.

FIG. 2 illustrates a flowchart of a method for reducing a water content in a water-and-solid-containing substance according to one embodiment of the present disclosure.

FIG. 3 illustrates a chart of a water content in a sludge after extraction treatment is performed on a water-containing sludge by using oil-free liquid dimethyl ether and oil-containing liquid dimethyl ether as a solvent respectively in one example.

FIG. 4 illustrates change of an amount of water in a mixed liquid consisting of water, crude oil and liquid dimethyl ether before and after change of temperature in one example.

### DETAILED DESCRIPTION

The embodiments of the present disclosure will be described below in detail. Unless defined otherwise, the technical or scientific terms used herein should have the same meanings as commonly understood by one of ordinary skill in the art to which the present disclosure pertains. The terms “a”, “an” and the like used herein do not denote a limitation of quantity, but denote the existence of at least one. The terms “or” and “alternatively” are not exclusive, but include at least one of the items (such as components) mentioned, and includes the case where a combination of the items mentioned may exist. The terms “comprises”, “comprising”, “includes”, “including” and the like cover other items in addition to those listed thereafter and equivalents thereof.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. Additionally, when using an expression of “about a first value−a second value,” the about is intended to modify both values. In at least some instances, the approximating language may correspond to the precision of an instrument for measuring the value. Here, and throughout the specification and claims, range limitations may be combined and/or interchanged, such ranges are identified and include all the sub-ranges contained therein unless context or language indicates otherwise.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

An embodiment of the present disclosure relates to a method and a system for reducing a water content in a water-and-solid-containing substance. The water-and-solid-containing substance possibly further contains an organic matter such as an oil. In the method and the system, a liquefied gas solvent is adopted for extracting water from the water-and-solid-containing substance, or further, for simultaneously extracting water and an organic matter, and then the liquefied gas solvent is separated into a liquefied-gas-solvent-rich phase and a water-rich phase by changing a temperature of the liquefied gas solvent containing the extracted water (and an organic matter) under a situation where the liquefied gas solvent remains in a liquid state, wherein the liquefied-gas-solvent-rich phase may be recycled as a solvent for extraction. In a process of changing the temperature, the temperature is always lower than a boiling point of the liquefied gas solvent under an operating pressure thereof, and thus liquid-liquid separation is performed under a situation where the liquefied gas solvent remains in a liquid state. As compared with a method of performing separation by evaporation of the liquefied gas solvent and then recycling the evaporated solvent after it is liquefied, the energy consumption can be obviously decreased. Particularly, in some embodiments, the operation of changing temperature refers to reducing temperature, wherein heat released in the process of reducing temperature may be further used for heating other substances which need to be heated in the system, and thereby the energy consumption can be further decreased.

The “liquefied gas solvent” refers to a liquid solvent which is formed by liquefaction of a substance which is a gas at ambient temperature and pressure. In some embodiments, “ambient temperature and pressure” refers to a temperature in a range of 20° C. to 25° C. and a pressure of 1 atm. The liquefied gas solvent at least can dissolve a certain amount of water. Particularly, the liquefied gas solvent can dissolve not only a certain amount of water, but also a certain amount of an organic matter. In other words, in some embodiment, the liquefied gas solvent at least can dissolve a certain amount of water and a certain amount of an organic matter.

The solvent may comprise at least one of dimethyl ether, methyl ethyl ether, methanal, methylamine, methane, ethane, propane, butane, methylene, ethylene, propylene, butene and methane chloride. In some embodiments, the solvent comprises at least one of dimethyl ether, methyl ethyl ether and methanal. In some specific embodiments, the solvent comprises dimethyl ether.

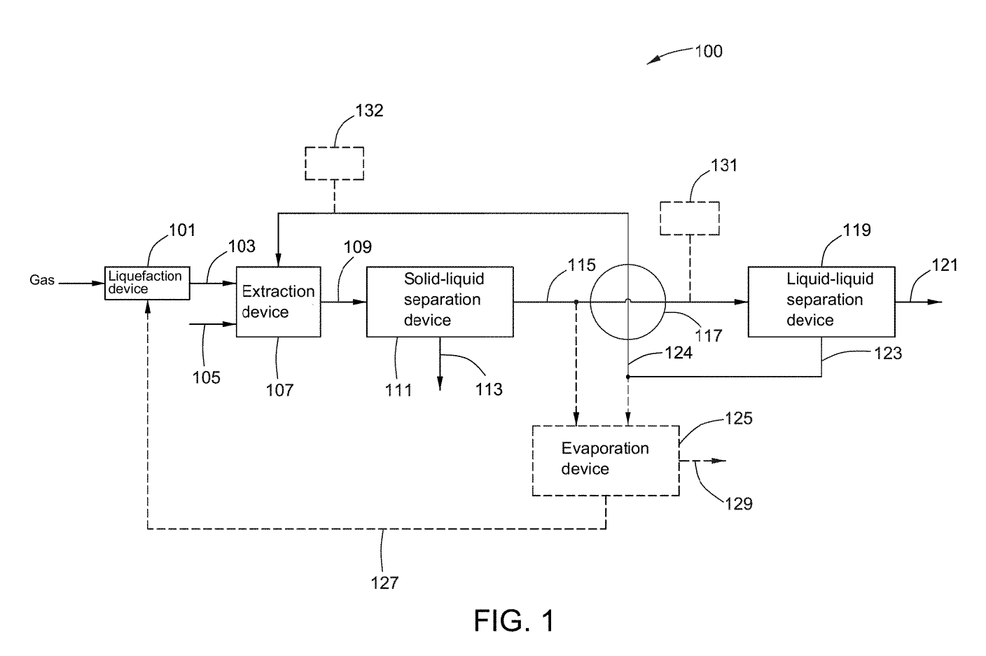

FIG. 1 illustrates a schematic diagram of a system 100 for reducing a water content in a water-and-solid-containing substance according to one embodiment of the present disclosure. The system 100 comprises a liquefaction device 101 for liquefying a substance which is a gas at ambient temperature and pressure to form a liquefied gas solvent 103. The system 100 further comprises an extraction device 107, which is capable of receiving the liquefied gas solvent 103 and a water-and-solid-containing substance 105 with a water content to be reduced and is used for mixing the liquefied gas solvent 103 and the water-and-solid-containing substance 105 to form a mixture 109. In this process, at least part of water and an organic matter (if any) in the water-and-solid-containing substance are extracted into the liquefied gas solvent 103, and thereby the water content in the water-and-solid-containing substance is decreased. The system 100 further comprises a solid-liquid separation device 111 for separating the mixture 109 into a substance 113 with a decreased water content and a solvent 115 with an increased water content, wherein the solvent with an increased water content comprises the liquefied gas solvent and the water extracted from the water-and-solid-containing substance. The system 100 further comprises a liquid-liquid separation device 119 for receiving the solvent 115 with an increased water content and separating water out of the solvent 115 with an increased water content by changing a temperature of the solvent 115 with an increased water content under a situation where the liquefied gas solvent remains in a liquid state, so as to separate the solvent 115 with an increased water content into a water-rich phase 121 and a liquefied-gas-solvent-rich phase 123, wherein the content of water in the water-rich phase 121 is higher than the content of water in the solvent 115 with an increased water content, and the content of the liquefied gas solvent in the liquefied-gas-solvent-rich phase 123 is higher than the content of the liquefied gas solvent in the solvent 115 with an increased water content. A recycling device 124 may be used for cycling at least part of the liquefied-gas-solvent-rich phase 123 to the extraction device 107 to be used as a solvent.

In some embodiments, the solid-liquid separation device 111 separates the mixture 109 into the substance 113 and the solvent 115 by physical separation methods such as filtration, settlement and cyclone separation, and may comprise at least one of solid-liquid separation devices such as a filtering device, a settlement device and a cyclone separation device. In some embodiments, pressure is kept substantially unchanged throughout the separation process in the liquid-liquid separation device 119, while only the temperature of the solvent 115 with an increased water content is changed, and simultaneously the temperature of the solvent 115 with an increased water content is kept to be lower than a boiling point of the liquefied gas solvent under a pressure at that moment, such that the liquefied gas solvent remains in a liquid state.

In some embodiments, in the liquid-liquid separation device 119, water is separated from the solvent 115 with an increased water content by reducing the temperature of the solvent 115 with an increased water content. In some embodiments, the temperature of the solvent 115 with an increased water content may be reduced by about 10-40° C. to separate water from the solvent 115 with an increased water content. In some embodiments, the temperature of the solvent 115 with an increased water content may be reduced from a range of 40-50° C. to a range of about 0-10° C., for example.

In some embodiments, the system 100 may further comprise a heat exchange device 117 for exchanging heat between the liquefied-gas-solvent-rich phase 123 which needs to flow from the liquid-liquid separation device 119 to the extraction device 107 and the solvent 115 with an increased water content which needs to flow from the solid-liquid separation device 111 to the liquid-liquid separation device 119, such that the temperature of the solvent 115 with an increased water content is reduced and the temperature of the liquefied-gas-solvent-rich phase 123 is increased. In some embodiments, other heat exchange devices may be further provided to utilize the heat in the system 100 as much as possible, so as to improve the energy efficiency and decrease the energy consumption. In some embodiments, a cooling device 131 may be further provided to further reduce the temperature of the solvent 115 with an increased water content. In some embodiments, a heating device 132 may be further provided to further increase the temperature of the liquefied-gas-solvent-rich phase 123.

If the water-and-solid-containing substance 105 further contains an organic matter such as an oil or a grease, in the extraction process, at least part of the organic matter is also extracted into the liquefied gas solvent, and thus the solvent 115 with an increased water content obtained in the solid-liquid separation device 11 also contains the organic matter from the water-and-solid-containing substance 105. When separation is performed on the solvent 115 with an increased water content in the liquid-liquid separation device 119, the organic matter therein mainly enters the liquefied-gas-solvent-rich phase 123. However, the existence of the organic matter substantially does not influence the capability of the liquefied-gas-solvent-rich phase 123 to extract the water, and thus the liquefied-gas-solvent-rich phase 123 may be directly cycled to the extraction device to be used as a solvent without separating the organic matter therefrom. After the liquefied-gas-solvent-rich phase 123 is cyclically used for a number of times, the concentration of the organic matter therein continuously increases, until the organic matter is saturated or is close to be saturated, and the liquefied-gas-solvent-rich phase 123 cannot very effectively extract the organic matter from the water-containing substance 105 any longer. At this moment, evaporation treatment may be performed on the liquefied-gas-solvent-rich phase. For example, the solvent is evaporated by means of heating or depressurization to obtain a gaseous solvent. By liquefying the resulting gaseous solvent, at least part of the liquefied gaseous solvent may be cycled to the extraction device 107 for use.

In some embodiments, as illustrated in FIG. 1, the system 100 further comprises an evaporation device 125 for evaporating the solvent from the liquefied-gas-solvent-rich phase 123 to obtain a gaseous solvent 127 when the liquefied-gas-solvent-rich phase 123 enriches at least one organic matter from the water-and-solid-containing substance 105 and a concentration of the at least one organic matter reaches a predetermined value, while the organic matter therein remains in a liquid state, such that the solvent 127 is separated from the organic matter 129. The gaseous solvent 127 may be liquefied in the liquefaction device 101 and then enter the extraction device 107 for use.

Specifically, in some embodiments, the approximate time of continuous cycling or the number of cycles, after which the concentration of the organic matter in the liquefied-gas-solvent-rich phase 123 reaches a predetermined value such as a saturated value or a value close to the saturated value, may be estimated in advance according to information such as the concentration of the organic matter in the water-and-solid-containing substance 105, etc. Therefore, when the system 100 is operated under certain conditions to reduce the water content in the water-and-solid-containing substance 105, the liquefied-gas-solvent-rich phase 123 may be input into the evaporation device 125 for evaporation whenever the time of cycling or the number of cycles reaches the estimated value. In some embodiments, the concentration of the organic matter in the liquefied-gas-solvent-rich phase may also be detected in real time, and compared with a predetermined reference value (such as the solubility of the organic matter in the liquefied gas solvent), so as to determine the time at which the liquefied-gas-solvent-rich phase 123 is to be input into the evaporation device 125 for evaporation treatment. For example, the liquefied-gas-solvent-rich phase 123 may be input into the evaporation device 125 for evaporation when the detected concentration is greater than or equal to the reference value. Therefore, the system 100 may further comprise a detection system or device (not shown) for implementing the real-time detection.

Part of the solvent 115 with an increased water content may directly enter the evaporation device 125 for evaporation. For example, about 1-50% (or further about 1-30%) of the solvent 115 with an increased water content may directly enter the evaporation device 125 for evaporation, and the remaining part still enters the liquid-liquid separation device 119 for liquid-liquid separation. In some embodiments, the liquefaction device 101 receives a certain amount of a replenishing gas solvent (a fresh gas solvent which does not come from the internal cycling of the system 100), liquefies the replenishing gas solvent and inputs the replenishing gas solvent into the extraction device 107 as a replenishing liquefied gas solvent, and part of the solvent 115 with an increased water content at a rear end is enabled to directly enter the evaporation device 125 for evaporation, so as to maintain the balance of the system.

An embodiment of the present disclosure further relates to a method for reducing a water content in a water-and-solid-containing substance, comprising: (a) mixing the water-and-solid-containing substance with a liquefied gas solvent to obtain a mixture and enabling at least part of water in the water-and-solid-containing substance to be extracted into the liquefied gas solvent; (b) separating the mixture into a substance with a decreased water content and a solvent with an increased water content, the solvent with an increased water content comprising the liquefied gas solvent and water extracted from the water-and-solid-containing substance; (c) separating the solvent with an increased water content into a liquefied-gas-solvent-rich phase and a water-rich phase by changing a temperature of the solvent with an increased water content, and in a process of changing the temperature, keeping the temperature to be lower than a boiling point of the liquefied gas solvent under a pressure in the process; and (d) returning at least part of the liquefied-gas-solvent-rich phase to step (a) to be used as a solvent.

If the water-and-solid-containing substance further contains an organic matter, at least part of the organic matter together with water is also extracted into the liquefied gas solvent, and thus the solvent with an increased water content contains the at least part of the organic matter. Under this situation, the method may further comprise: (e) repeating steps (a) to (d) till a concentration of the organic matter in the liquefied-gas-solvent-rich phase reaches a predetermined value; (f) evaporating the solvent from the liquefied-gas-solvent-rich phase after step (e) to obtain a gaseous solvent; and (g) liquefying the gaseous solvent obtained in step (f) and returning at least part of the liquefied gaseous solvent to step (a) to be used as a solvent.

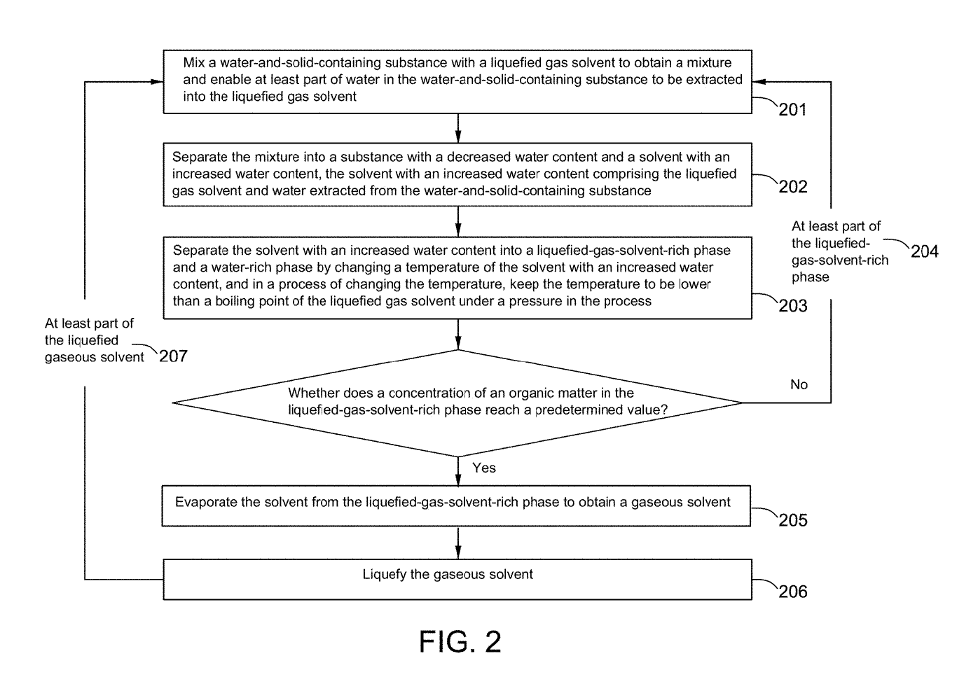

In some embodiments, as illustrated in FIG. 2, the method may comprise: in step 201, mixing a water-and-solid-containing substance with a liquefied gas solvent to obtain a mixture and enabling at least part of water in the water-and-solid-containing substance to be extracted into the liquefied gas solvent; in step 202, separating the mixture into a substance with a decreased water content and a solvent with an increased water content, the solvent with an increased water content comprising the liquefied gas solvent and water extracted from the water-and-solid-containing substance; in step 203, separating the solvent with an increased water content into a liquefied-gas-solvent-rich phase and a water-rich phase by changing a temperature of the solvent with an increased water content, and in a process of changing the temperature, keeping the temperature to be lower than a boiling point of the liquefied gas solvent under a pressure in the process; in step 204, returning at least part of the liquefied-gas-solvent-rich phase to step 201 to be used as a solvent when a concentration of an organic matter in the liquefied-gas-solvent-rich phase does not reach a predetermined value; and in step 205, evaporating the solvent from the liquefied-gas-solvent-rich phase to obtain a gaseous solvent when the concentration of the organic matter in the liquefied-gas-solvent-rich phase reaches the predetermined value. Besides, in step 206, the gaseous solvent obtained in step 205 may also be liquefied, and in step 207, at least part of the liquefied gaseous solvent in step 206 is returned to step 201 to be used as a solvent.

Specific steps and operations in the method may be the same as or similar to the steps and operations in the process described in combination with the system 100 above, and thus will not be repetitively described here.

In the system or method in the above-mentioned embodiments, by using a great amount of a liquefied gas solvent and repetitively and cyclically using the liquefied gas solvent, not only can the water in the treated substance be decreased, but also the organic matters such as oil and grease in the substance may be decreased, and reusable water and oil can be obtained. For example, when the system or the method is used for treating oil-containing sludge produced in an oil field, the obtained oil may be cycled to a crude oil treatment system for reuse. Besides, by adopting the system or the method in the above-mentioned embodiments, the consumption of energy needed for evaporating the liquefied gas solvent and then liquefying the gas solvent is reduced. In addition, the mixing and extraction performed in the extraction device 107, the separation performed in the solid-liquid separation device 111 and the liquid-liquid separation device 119, the solvent recycling performed in the recycling device 124, and the like, can all be performed at a temperature and a pressure where energy consumption is low, e.g., can be performed at a temperature within a range of about 0° C. to 50° C. and at a pressure at which the liquefied gas solvent can remain in a liquid phase, and thus the energy consumption can be further reduced. Herein, the pressure at which the liquefied gas solvent remains in a liquid phase refers to a pressure higher than the saturated vapor pressure of the liquefied gas solvent at the temperature at which the liquefied gas solvent stays. Therefore, the overall energy consumption of the system and the method is very low, and as compared with the system and the method for recycling the liquefied gas solvent by means of direct evaporation and then liquefaction, a cost advantage is achieved.

### EXAMPLE 1

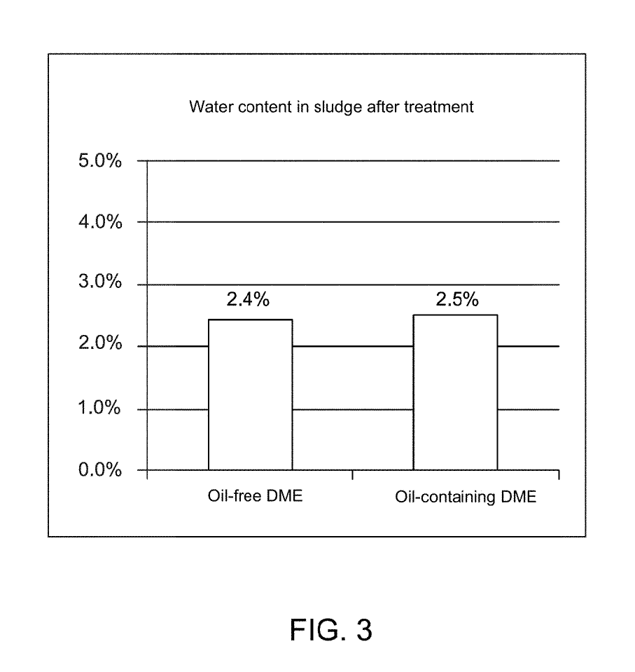

In this example, oil-free liquid dimethyl ether and liquid dimethyl ether added with 20 wt % of oil were respectively used as a solvent to perform extraction treatment on a sludge containing 37.4 wt % of water to reduce a water content in the sludge, and capabilities of the two kinds of liquid dimethyl ether to reduce the water content were compared. Under operating conditions of 8° C. and 0.4 MPa, the liquid dimethyl ether was mixed with the sludge to be treated at a weight ratio of 10:1 of dimethyl ether to sludge, and finally a sludge containing 2.4 wt % of water and a sludge containing 2.5 wt % of water were respectively obtained. As illustrated in FIG. 3, the water content of the sludge treated by using the oil-free liquid dimethyl ether as the solvent was reduced to 2.4 wt %, and the water content of the sludge treated by using liquid dimethyl ether added with 20 wt % of oil as the solvent was reduced to 2.5 wt %.This indicates that the effect of extraction for water removal by using an oil-containing dimethyl ether is substantially as good as the effect of extraction for water removal by using an oil-free dimethyl ether.

### EXAMPLE 2

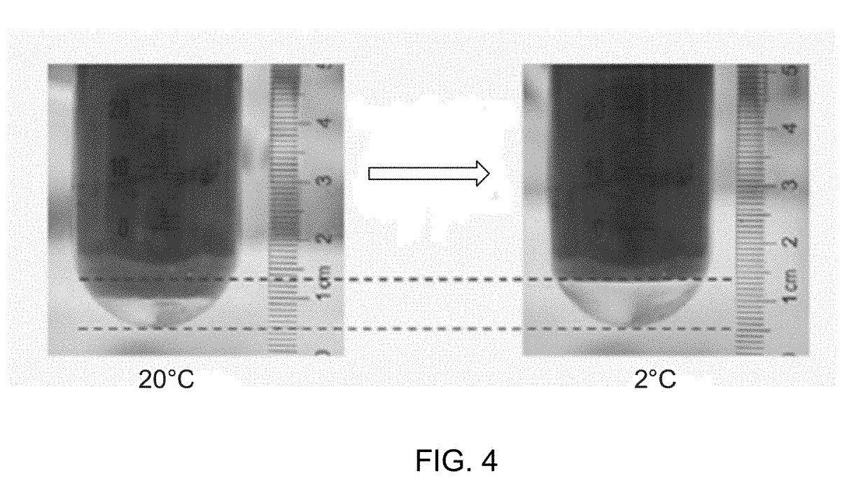

In this example, a temperature of a mixed liquid consisting of 2.5 g of water, 2.5 g of crude oil and 33 g of liquid dimethyl ether in a container was reduced from 20° C. to 2° C., and results were as shown in FIG. 4. After the temperature was reduced, the amount of water at the bottom of the container was obviously increased, indicating that the water could be separated from the oil-containing liquid dimethyl ether by reducing the temperature. This indicates that water can be separated from dimethyl ether by reducing temperature even in the presence of oil.

This description describes the present disclosure with reference to specific embodiments including best modes, and can help one skilled in the art to perform experimental operations. These operations include using any device and system and using any particular method. The patent scope of the present disclosure shall be defined by the claims and may include other examples in this technical field. If the other examples are not different from the written wording of the claims in structure or they have structures equivalent to the structures described in the claims, these examples shall be all considered as included in the scope defined by the claims of the present disclosure.

What is claimed is:

1. A method for reducing a water content in a water-and-solid-containing substance, comprising:
(a) mixing the water-and-solid-containing substance with a liquefied gas solvent to obtain a mixture and enabling at least part of water in the water-and-solid-containing substance to be extracted into the liquefied gas solvent;
(b) separating the mixture into a substance with a decreased water content and a solvent with an increased water content, the solvent with an increased water content comprising the liquefied gas solvent and water extracted from the water-and-solid-containing substance;
(c) separating the solvent with an increased water content into a liquefied-gas-solvent-rich phase and a water-rich phase by changing a temperature of the solvent with an increased water content, and in a process of changing the temperature, keeping the temperature to be lower than a boiling point of the liquefied gas solvent under a pressure in the process; and
(d) returning at least part of the liquefied-gas-solvent-rich phase to step (a) to be used as a solvent.

2. The method according to claim 1, wherein the water-and-solid-containing substance further contains at least one organic matter, the step of mixing the water-and-solid-containing substance with the liquefied gas solvent comprises enabling at least part of the organic matter to be extracted into the liquefied gas solvent, and the solvent with an increased water content contains the at least part of the organic matter.

3. The method according to claim 2, further comprising: (e) repeating steps (a) to (d) till a concentration of the organic matter in the liquefied-gas-solvent-rich phase reaches a predetermined value.

4. The method according to claim 3, further comprising: (f) evaporating the solvent from the liquefied-gas-solvent-rich phase after step (e) to obtain a gaseous solvent.

5. The method according to claim 4, further comprising: (g) liquefying the gaseous solvent obtained in step (f) and returning at least part of a resulting liquefied gaseous solvent to step (a) to be used as a solvent.

6. The method according to claim 2, wherein the at least one organic matter comprises at least one oil.

7. The method according to claim 1, wherein the liquefied gas solvent comprises dimethyl ether, methyl ethyl ether, methanal, methylamine, methane, ethane, propane, butane, methylene, ethylene, propylene, butene, methane chloride or a combination thereof.

8. The method according to claim 1, wherein the liquefied gas solvent comprises dimethyl ether, methyl ethyl ether, methanal or a combination thereof.

9. The method according to claim 1, wherein changing the temperature of the solvent with an increased water content comprises reducing the temperature of the solvent with an increased water content.

10. The method according to claim 9, wherein the temperature of the solvent with an increased water content is reduced to a range of 0-10° C.

11. The method according to claim 9, wherein reducing the temperature of the solvent with an increased water content comprises exchanging heat between the solvent with an increased water content and the liquefied-gas-solvent-rich phase obtained in step (c).

12. A system for reducing a water content in a water-and-solid-containing substance, comprising:
an extraction device for mixing the water-and-solid-containing substance with a liquefied gas solvent to obtain a mixture and enabling at least part of water in the water-and-solid-containing substance to be extracted into the liquefied gas solvent;
a solid-liquid separation device for separating the mixture into a substance with a decreased water content and a solvent with an increased water content, the solvent with an increased water content comprising the liquefied gas solvent and water extracted from the water-and-solid-containing substance;
a liquid-liquid separation device for separating the solvent with an increased water content into a liquefied-gas-solvent-rich phase and a water-rich phase by changing a temperature of the solvent with an increased water content, and in a process of changing the temperature, keeping the temperature to be lower than a boiling point of the liquefied gas solvent under a pressure in the process; and
a recycling device for returning at least part of the liquefied-gas-solvent-rich phase to the extraction device to be used as a solvent.

13. The system according to claim 12, further comprising an evaporation device for evaporating the solvent from the liquefied-gas-solvent-rich phase to obtain a gaseous solvent when the liquefied-gas-solvent-rich phase enriches at least one organic matter from the water-and-solid-containing substance and a concentration of the at least one organic matter reaches a predetermined value.

14. The system according to claim 13, further comprising a liquefaction device for liquefying the gaseous solvent obtained in the evaporation device to obtain a liquefied gaseous solvent useful in the extraction device.

15. The system according to claim 12, further comprising a heat exchange device for exchanging heat between the solvent with an increased water content to flow from the solid-liquid separation device to the liquid-liquid separation device and the liquefied-gas-solvent-rich phase to be returned from the liquid-liquid separation device to the extraction device.
